(19) United States
(12) Patent Application Publication
(10) Pub. No.: US 2013/0326238 A1
(43) Pub. Date: Dec. 5, 2013

(54) SHARED ACCESS SYSTEM

(71) Applicant: Yung-Chiang Chu, Taipei (TW)

(72) Inventor: Yung-Chiang Chu, Taipei (TW)

(73) Assignee: FLUIDITECH IP LIMITED, Victoria (SC)

(21) Appl. No.: 13/485,218

(22) Filed: May 31, 2012

(51) Int. Cl. G06F 1/26

(52) U.S. Cl. 713/300

(57) ABSTRACT

A shared access system is for a plurality of shared access devices to share data and power, and one of the shared access devices includes an instruction unit, a connecting unit, a storage unit, a power unit and a processing unit. The instruction unit is for storing a plurality of application modes related to a plurality of multifunctional shared applications respectively; the connecting unit is for receiving and transmitting the data and transmitting the power; the storage unit has a storage space for storing the data; the power unit stores the power; and the processing unit is coupled to the instruction unit, the connecting unit, the storage unit and the power unit, and the processing unit determines sharing the data and the power according to the execution of one of the application modes.

### FIELD OF THE INVENTION

The present invention relates to a shared access system, in particular to the shared access system for sharing data and power between several shared access devices.

### BACKGROUND OF THE INVENTION

In a prior art, if a user wants to share computer data, the user has to copy the computer data to a multimedia storage device (such as a portable hard disk or a thumb drive), and transfer the file from the multimedia storage device to achieve the effect of sharing the computer data.

However, the aforementioned method simply conducts a 1-to-1 one-way file transmission and cannot share data or files between users at the same time. Therefore, the conventional method is inconvenient, particularly in the occasion that the users need to share information with each other in a conference.

In view of the aforementioned problem, the present invention provides a shared access system to overcome the problem of the prior art.

### SUMMARY OF THE INVENTION

It is a primary objective of the present invention to provide a shared access system comprising a plurality of shared access devices, and the shared access system is provided for sharing data and power between the shared access devices.

To achieve the aforementioned and other objectives, the present invention provides a shared access system provided for a plurality of shared access devices to share data and power, wherein one of the shared access devices comprises an instruction unit, a connecting unit, a storage unit, a power unit and a processing unit. The instruction unit is provided for storing a plurality of application modes related to the multifunctional shared applications; the connecting unit is provided for transmitting and receiving the data and transmitting the power; the storage unit has a storage space for storing the data; the power unit stores the power; and the processing unit is coupled to the instruction unit, the connecting unit, the storage unit and the power unit, and the processing unit determines sharing the data and the power according to an execution of one of the application modes.

Compared with the prior art, the shared access system of the present invention allows users to share data and power. Several users can perform file sharing with one another directly through a plurality of shared access devices and also can extend the working time of the shared access devices by stacking several shared access devices together, and perform a file management such as copying files directly between the shared access devices. Further, the shared access devices can perform file sharing and editing through the shared access devices at the same time in a presentation without requiring any computer device. Further, the shared access device provides several ways of sharing projected images, such as displaying on an extended computer screen, a split screen, and a 3D screen, etc. Therefore, the shared access system of the present invention can provide a multifunctional sharing mechanism.

### BRIEF DESCRIPTION OF THE DRAWINGS

FIG. 1 is a schematic block diagram of a shared access system in accordance with a first preferred embodiment of the present invention;

FIG. 2 is a schematic block diagram of a shared access system in accordance with a second preferred embodiment of the present invention;

FIG. 3 is a schematic block diagram of a shared access system in accordance with a third preferred embodiment of the present invention;

FIG. 4 is a schematic view of an operation at an application mode in accordance with the third preferred embodiment of the present invention; and

FIG. 5 is a schematic view of another operation at an application mode in accordance with the third preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

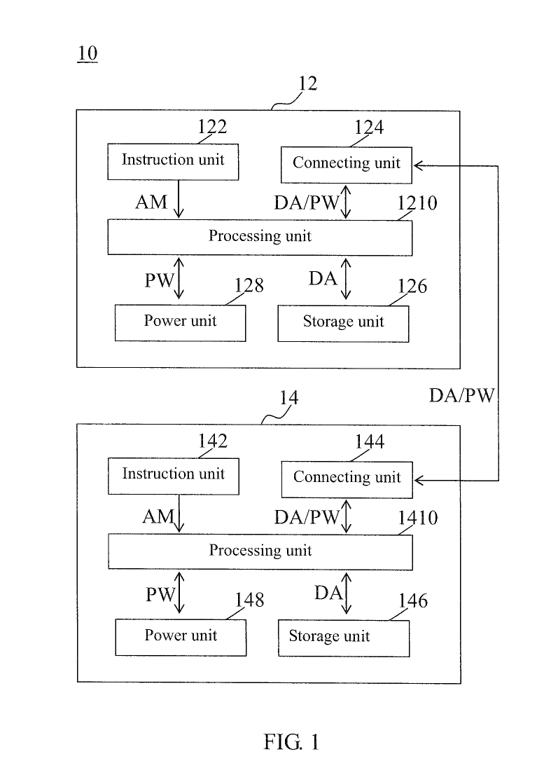

With reference to FIG. 1 for a schematic block diagram of a shared access system in accordance with the first preferred embodiment of the present invention, the shared access system 10 is provided for a plurality of shared access devices 12, 14 to share data DA and power PW with one another. For example, the sharing application includes file managements (such as EDIT, COPY and DELETE) of the file DA, and the file DA is projected directly from the shared access device 12, 14, and the data DA are displayed in 3D, and the power PW is charged and supplied between the shared access devices 12, 14.

Wherein, each of the shared access devices 12, 14 comprises an instruction unit 122, 142, a connecting unit 124, 144, a storage unit 126, 146, a power unit 128, 148 and a processing unit 1210, 1410.

The instruction unit 122, 142 is provided for storing a plurality of application modes AM related to the multifunctional shared applications. A user can freely select one of the application modes AM, or add an additional application mode AM by updates. For example, the application modes AM is an application program stored in an electrically erasable programmable read only memory (EEPROM), a random access memory (RAM), a read only memory (ROM) or any other external memory.

The application modes AM are listed and described as follows:

(1) The processing unit 1210, 1410 is coupled to the power unit 128, 148 and the connecting unit 124, 144 according to one of the application modes AM to receive the power 124, 144 of the power unit 128, 148 from the connecting unit and transmit the power PW of the power unit 128, 148 to one of the connecting units 124, 144.

(2) The processing unit 1210, 1410 is coupled to the storage unit 126, 146 and the connecting unit 124, 144 according to one of the application modes AM and provided for the storage unit 126, 146 to obtain the data DA from the connecting unit 124, 144 or transmit the data DA of the storage unit 126, 146 to the connecting unit 124, 144.

The connecting unit 124, 144 transmits and receives the data DA and transmits the power PW. Wherein, the connecting unit 124, 144 complies with the transmission mode of serial data transmissions or parallel data transmission, such as the transmissions via universal serial bus (USB), IEEE (FireWire), high definition multimedia interface (HDMI), video graphics array (VGA), or APPLE 30 pins. In addition, the data DA can be video data, audio data or text data.

In FIG. 1, the storage unit 126, 146 has a storage space for storing the data DA. For example, the storage unit 126, 146 is a built-in or external hard disk drive (HDD), a built-in or external solid state disk or solid state drive (SSD), a flash disk or an online hard drive.

The power unit 128, 148 stores the power PW. Wherein, the power PW can be supplied from a built-in battery (such as a lithium battery) or a replaceable battery (such as a primary or secondary battery including an alkaline or carbon-zinc battery).

The processing unit 1210, 1410 is coupled to the instruction unit 122, 142, the connecting unit 124, 144, the storage unit 126, 146 and the power unit 128, 148. Wherein, the processing unit 1210, 1410 determines sharing the data DA and the power PW according to an execution of one of the application modes AM.

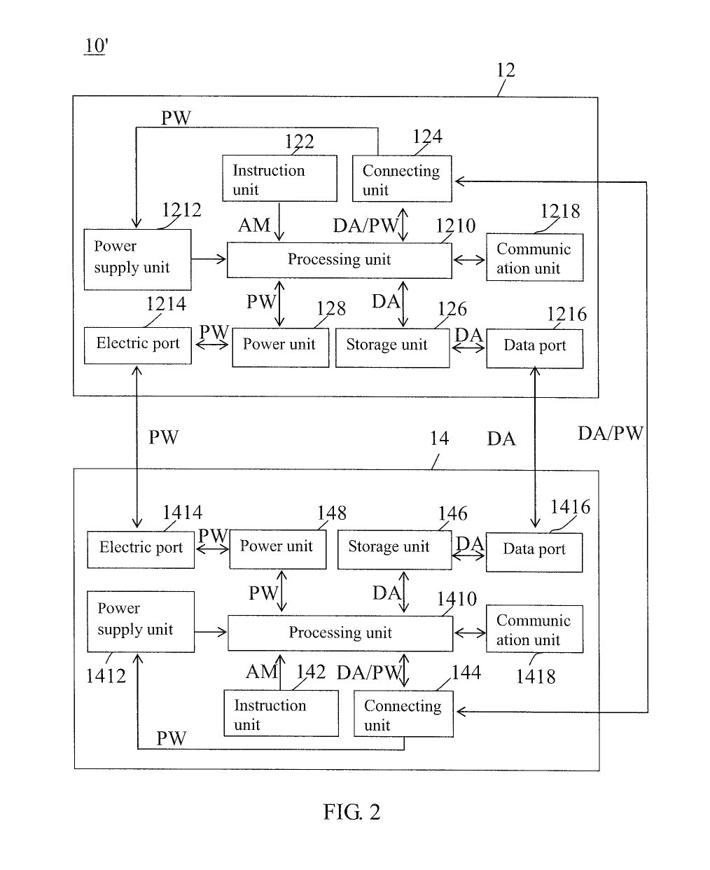

With reference to FIG. 2 for a schematic block diagram of a shared access system in accordance with the second preferred embodiment of the present invention, any one of the shared access devices 12, 14 of the shared access system 10′ further comprises a power supply unit 1212, 1412, an electric port 1214, 1414, a data port 1216, 1416 and a communication unit 1218, 1418 in addition to the instruction unit 122, 142, the connecting unit 124, 144, the storage unit 126, 146, the power unit 128, 148 and the processing unit 1210, 1410.

The power supply unit 1212, 1412 is coupled to the connecting unit 124, 144 and the power unit 128, 148 and provided for receiving an AC or DC voltage and converting the AC or DC voltage into the power PW to be stored in the power unit 128, 148. When the power supply unit 1212, 1412 receives voltage, the power supply unit 1212, 1412 has the functions of filtering, rectifying, boasting or bucking the voltage.

The power port 1214, 1414 is coupled to the power unit 128, 148 directly for receiving the power PW generated between the shared access devices 12, 14. In a preferred embodiment, the shared access devices 12, 14 are designated as a primary shared access device 12 and a secondary shared access device 14 respectively, and the primary shared access device 12 has a data port 1216, 1416 coupled to the processing unit 1210, 1410 directly for accessing the data DA stored in the storage unit 126, 146 of one of the shared access devices 12, 14.

The shared access devices 12, 14 can transmit the data DA or the power PW between the shared access devices 12, 14 directly without requiring the connecting unit 124, 144 (since the connecting unit 124, 144 requires a transmission cable to connect to a computer device or a power device for the transmission of the data DA or the power PW). In other words, users no longer require an additional transmission cable for the data and power transmissions in order to share the data DA or the power PW. In a preferred embodiment, the power port 1214, 1414 and the data port 1216, 1416 can be an assembly such as a conductive column or a conductive plate.

The communication unit 1218, 1418 is coupled to the processing unit 1210, 1410. Wherein, the communication unit 1218, 1418 transmits the data DA, and the communication unit 1218, 1418 complies with a wireless data transmission specification including the wireless fidelity, Bluetooth and mobile communication protocols.

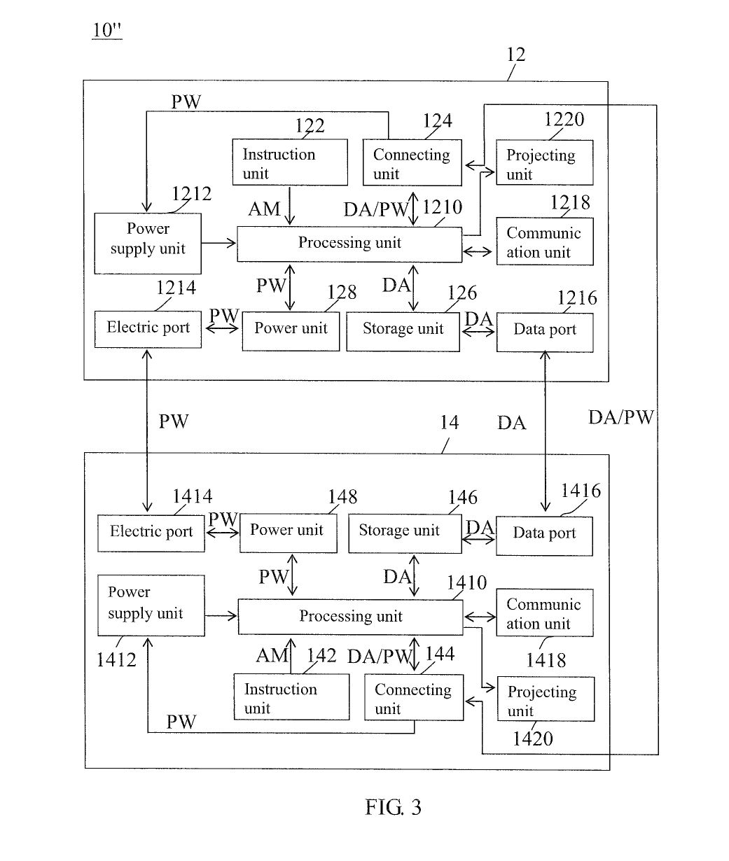

With reference to FIG. 3 for a schematic block diagram of a shared access system in accordance with the third preferred embodiment of the present invention, any one of the shared access devices 12, 14 of the shared access system 10″ further comprises a projecting unit 1220, 1420 in addition to the instruction unit 122, 142, the connecting unit 124, 144, the storage unit 126, 146, the power unit 128, 148 and the processing unit 1210, 1410.

The projecting unit 1220, 1420 is coupled to the processing unit 1210, 1410 and provided for displaying the data DA stored in the storage unit 126, 146 or displaying the data DA transmitted from the connecting unit 124, 144. Wherein, the projecting unit 1220, 1420 includes an optical system comprised of a lens and a light source. Further, the data DA situated at the connecting unit 124, 144 are the data DA including a video signal received after the connecting unit 124, 144 is coupled to a display port of an external device such as a personal computer (not shown in the figure).

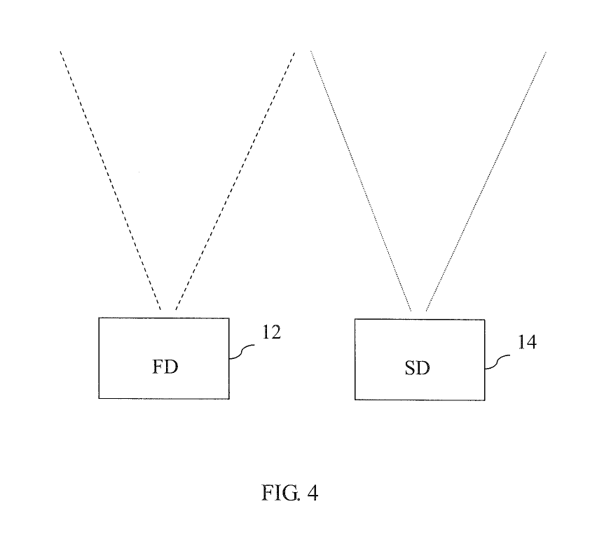

Refer to FIG. 4 together. Since the shared access device 12 is designated as a primary control terminal in this embodiment, and the storage unit 126 stores the data DA, therefore the application mode AM further includes the transmission of the data DA to the shared access device 14 through the connecting unit 124 to allow the projecting unit 1420 to project the same data DA of the projecting unit 1220, in addition to the transmission of the data DA stored in the storage unit 126 to the projecting unit 1220.

In another preferred embodiment, the application mode AM of the shared access system 10″ is to divide the data stored in the storage unit 126 or convert the data into first data FD and second data SD. Wherein, the first data FD are transmitted to the projecting unit 1220 and the second data SD are transmitted to the connecting unit 124, so that the second data DS are displayed by the projecting unit 142 of the shared access device 14. In this preferred embodiment, the shared access system 10″ shares the data DA including the first data FD and the second data SD through the shared access devices 12, 14.

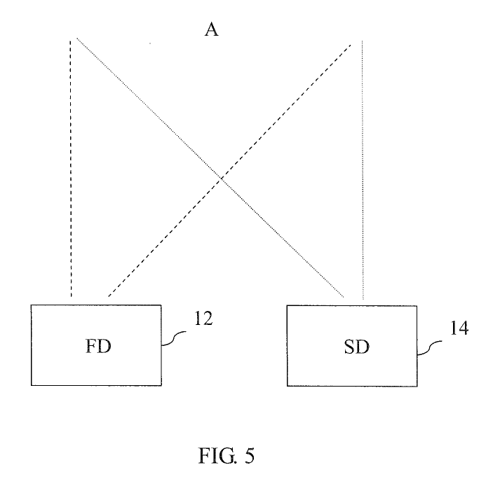

In another preferred embodiment, the first data FD and the second data SD contain at least one of the related color, angle, phase difference, brightness and depth of field required for generating 3D images. In FIG. 5, when the projecting unit 1220, 1420 performs a projection by a distance equal to the distance between two human eyes, the first data FD of the projecting unit 1220 are superimposed with the second data SD of the projecting unit 1420 in a same display area A, and the 3D image with the required color, angle, phase difference, brightness and depth of field is generated in the area A.

In summation, the shared access system of the present invention provides a multifunctional sharing mechanism, so that several users can share files with one another through a plurality of shared access devices and extend the working time of the shared access devices by stacking several shared access devices together and perform the file management between the shared access devices directly. In addition, the shared access devices can perform file sharing and editing at the same time in a presentation through the shared access devices directly without requiring a computer device. Further, the shared access device provides a way of sharing different image projections such as the display on an extended computer screen, a split screen, and a 3D screen.

While the invention has been described by means of specific embodiments, numerous modifications and variations could be made thereto by those skilled in the art without departing from the scope and spirit of the invention set forth in the claims.

What is claimed is:

1. A shared access system, provided for a plurality of shared access devices to share data and power, and one of the shared access devices comprising;
an instruction unit, for storing a plurality of application modes related to a plurality of multifunctional shared applications respectively;
a connecting unit, for supplying and receiving the data and transmitting the power;
a storage unit, having a storage space, for storing the data;
a power unit, for storing the power; and
a processing unit, coupled to the instruction unit, the connecting unit, the storage unit and the power unit, for determining sharing the data and the power according to an execution of one of the application modes.

2. The shared access system of claim 1, wherein the connecting unit complies with a serial data transmission mode or a parallel data transmission mode.

3. The shared access system of claim 2, further comprising a power supply unit coupled to the connecting unit and the power unit for receiving an AC or DC voltage, and converting the AC or DC voltage into the power to be stored in the power unit.

4. The shared access system of claim 2, further comprising a power port directly coupled to the power unit for receiving the power generated by another shared access device.

5. The shared access system of claim 2, further comprising a data port coupled to the processing unit directly for accessing the data from the storage unit of one of the shared access devices.

6. The shared access system of claim 2, further comprising a communication unit coupled to the processing unit for transmitting the data, and the communication unit complying with a wireless data transmission specification selected from the collection of wireless fidelity (Wi-Fi), Bluetooth and a mobile communication protocol and a cable data transmission specification.

7. The shared access system of claim 1, wherein the processing unit is coupled to the power unit and the connecting unit according to one of the application modes to allow the power unit to selectively access the power from the connecting unit and transmit the power of the power unit to the connecting unit.

8. The shared access system of claim 1, wherein the processing unit is coupled to the storage unit and the connecting unit according to one of the application modes to allow the storage unit to selectively access the data from the connecting unit and transmit the data of the storage unit to the connecting unit.

9. The shared access system of claim 1, further comprising a projecting unit coupled to the processing unit for displaying the data stored in the storage unit and/or the data transmitted from the connecting unit.

10. The shared access system of claim 9, wherein the processing unit transmits the data stored in the storage unit to the projecting unit and the connecting unit simultaneously according one of the application modes.

11. The shared access system of claim 9, wherein the processing unit divides or converts the data stored in the storage unit into first data and second data according to one of the application modes, and the first data are transmitted to the projecting unit and the second data are transmitted to the connecting unit.

12. The shared access system of claim 10, wherein the first data and the second data comprise related color, angle, phase difference, brightness and depth of field required for generating a 3D image.
